(19) United States
(12) Patent Application Publication
(10) Pub. No.: US 2015/0048744 A1
(43) Pub. Date: Feb. 19, 2015

(54) LIGHT EMITTING DIODE DRIVING CIRCUIT AND LIGHT EMITTING DIODE ILLUMINATION APPARATUS INCLUDING THE SAME

(71) Applicant: SILICON WORKS CO., LTD., Daejeon-si (KR)

(72) Inventors: So Bong Shin, Daejeon-si (KR); Yong Goo Kim, Daejeon-si (KR); Ok Hwan Kwon, Daejeon-si (KR); Won Ji Lee, Chenahn-si (KR); Young Suk Son, Daejeon-si (KR)

(21) Appl. No.: 14/390,022

(22) PCT Filed: Apr. 2, 2013
(86) PCT No.: PCT/KR2013/002727

§ 371 Date: Oct. 1, 2014

(30) Foreign Application Priority Data
Apr. 2, 2012 (KR) 10-2012-0034075

(51) Int. Cl. H05B 33/08

(52) U.S. Cl. CPC H05B 33/0824; H05B 33/0809
USPC 315/186

(57) ABSTRACT

A LED driving circuit drives a plurality of LED (Light Emitting Diode) groups, has a common voltage that is changed according to an input voltage of the plurality of LED groups, and includes a common node, a plurality of phase switches arranged between the output terminals of the plurality of LED groups and the common node, and a plurality of phase switch control units that form current flows among a corresponding LED group, a corresponding phase switch, and the common node in phase sections of the input voltage based on the common voltage and a corresponding reference voltage, the input voltage having a time-variable phase. Accordingly, the LED driving circuit can correct a power factor without using an inductor or a capacitor.

### TECHNICAL FIELD

The present invention relates to a light emitting diode driving circuit capable of correcting a POWER FACTOR and a light emitting diode illumination apparatus including the same.

### BACKGROUND ART

A recent illumination technology employs a light emitting diode (LED) to reduce energy, and particularly, a high luminance light emitting diode may be distinguished from other light sources in terms of an energy consumption amount, the lifespan, light quality and the like.

The light emitting diode may be driven through a constant current, and an illumination apparatus employing such a light emitting diode as a light source may require an additional circuit for power factor correction and the like. In order to solve such a problem, a light emitting diode illumination apparatus employing an AC DIRECT TYPE has emerged. Such a light emitting diode illumination apparatus employing an AC direct type may generate a rectified voltage from a commercial AC power source and drive a light emitting diode, and particularly, may directly use the rectified voltage as an input voltage without using an inductor and a capacitor, thereby performing POWER FACTOR CORRECTION.

Korean Patent Registration No. 10-1128680 discloses the aforementioned light emitting diode illumination apparatus employing an AC direct type.

However, as light emitting diode illuminations have been continuously spread, an illumination apparatus employing a light emitting diode as a light source is required to guarantee low power consumption and a corrected power factor while having simple parts and a simple structure.

### DISCLOSURE

### Technical Problem

Accordingly, the present invention has been made in an effort to solve the problems occurring in the related art, and an object of the present invention is to provide a light emitting diode driving circuit capable of correcting a power factor with a simple structure and a light emitting diode illumination apparatus using the same.

Another object of the present invention is to provide a light emitting diode driving circuit employing an AC direct type, capable of correcting a power factor by using a common voltage that may be changed according to a time-variable phase of an input voltage, and a light emitting diode illumination apparatus using the same.

### technical Solution

In embodiments, an LED driving circuit drives a plurality of serially connected LED (Light Emitting Diodes) groups by using a rectified voltage obtained by rectifying an AC voltage. The LED driving circuit includes a reference voltage generation circuit that generates a plurality of reference voltages corresponding to the plurality of LED groups and having levels different from each other; a common ground resistor; and a plurality of switching circuits connected to output terminals of the plurality of LED groups, receiving a high reference voltage as the LED groups go farther from a position to which the rectified voltage is applied, and receiving a corresponding reference voltage and a common voltage of the common ground resistor and forming a current path between a corresponding LED group and the common ground resistor for changing the common voltage of the common ground resistor, the current path being formed between an LED group, which is farthest from the position to which the rectified voltage is applied among currently turned-on LED groups, and the common ground resistor.

The reference voltage generation circuit includes a plurality of serially connected resistors to which a supply voltage is applied, and nodes in the plurality of resistors may output the plurality of reference voltages. The reference voltage generation circuit may further include an enable circuit that selectively activates application of the supply voltage to the plurality of resistors by an initial reference voltage.

Each of the plurality of switching circuits includes a comparator that compares the corresponding reference voltage with the common voltage, and a switching element that selectively forms the current path by output of the comparator and changes the common voltage of the common ground resistor.

In embodiments, an LED driving circuit drives a plurality of LED (Light Emitting Diode) groups. The LED driving circuit includes: a common node having a common voltage that is changed according to an input voltage of the plurality of LED groups, the input voltage having a time-variable phase; a plurality of phase switches arranged between output terminals of the plurality of LED groups and the common node; and a plurality of phase switch control units that form current flows among a corresponding LED group, a corresponding phase switch, and the common node in phase sections of the input voltage based on the common voltage and a corresponding reference voltage.

Each of the plurality of phase switch control units may form the current flow in a corresponding section of the input voltage, and may not form the current flow in remaining phase sections.

The common node may connect output terminals of the plurality of phase switches, input terminals of the plurality of phase switch control units, and a common ground resistor connected to ground to one another. The common node may form a current flow between an output terminal of the LED (Light Emitting Diode) and the ground only in a corresponding phase section of the input voltage even though at least a part of the plurality of phase switches is turned on. The common voltage may follow the time-variable phase of the input voltage.

Each of the plurality of phase switch control units may turn on the phase switch when the corresponding reference voltage is higher than the common voltage. Each of the plurality of phase switch control units may include a comparator that receives the corresponding reference voltage through a positive terminal, receives the common voltage through a negative terminal, and connects a corresponding phase switch to an output terminal.

The LED driving circuit may further include a reference voltage generation unit that generates a plurality of reference voltages corresponding to a plurality of phase sections of the input voltage and provides a reference voltage corresponding to the corresponding phase section as the corresponding reference voltage.

The LED driving circuit may further include a power supply that provides the input voltage to an input terminal of the LED group.

The plurality of phase switch control units may receive a high reference voltage as the LED group goes farther from a position to which the input voltage is applied, receive a corresponding reference voltage and the common voltage, and form a current path between a corresponding LED group and the common node to change the common voltage, and the current path may be formed between an LED group, which is farthest from the position to which the rectified voltage is applied among currently turned-on LED groups, and the common ground resistor.

In embodiments, an LED illumination apparatus includes an LED (Light Emitting Diode) group and an LED (Light Emitting Diode) driving circuit. The LED driving circuit includes: a common node having a common voltage that is changed according to an input voltage of the LED group, the input voltage having a time-variable phase; a phase switch arranged between an output terminal of the LED group and the common node; and a phase switch control unit that forms a current flow among the LED group, the phase switch, and the common node in a corresponding phase section of the input voltage based on the common voltage and a corresponding reference voltage.

In embodiments, an LED driving circuit drives N (N is a natural number) serially connected LED (Light Emitting Diode) groups. The LED driving circuit includes: a common ground resistor; and N switching circuits connected to output terminals of the LED groups, commonly connected to the common ground resistor, and corresponding to the LED groups, wherein, in the N switching circuits, a N^{th} switching circuit receives a high reference voltage as compared with a N−1^{th} switching circuit and forms a current path between a N^{th} LED group and the common ground resistor.

The LED driving circuit may further include a reference voltage generation circuit that applies a higher reference voltage to the N^{th} switching circuit as compared with the N−1^{th} switching circuit.

The switching circuit may include a comparator that compares the reference voltage with the common voltage, and a switching element that is turned on and off by output of the comparator, selectively forms the current path, and changes the common voltage of the common ground resistor. A rectified voltage obtained by rectifying an AC voltage may be applied to the LED groups.

The reference voltage generation circuit may include a plurality of serially connected resistors to which a supply voltage is applied, and output reference voltages according to nodes between the plurality of resistors. The reference voltage generation circuit may further include an enable circuit that selectively activates application of the supply voltage to the plurality of resistors by an initial reference voltage.

### Advantageous Effects

A light emitting diode driving circuit and a light emitting diode illumination apparatus using the same according to an embodiment of the present invention can correct a power factor without using an inductor or a capacitor.

The light emitting diode driving circuit and the light emitting diode illumination apparatus using the same according to an embodiment of the present invention can define a current flowing through each channel of a light emitting diode by using a common ground voltage, and to simplify parts constituting the light emitting diode driving circuit.

### BRIEF DESCRIPTION OF THE DRAWINGS

The above objects, and other features and advantages of the present invention will become more apparent after a reading of the following detailed description taken in conjunction with the drawings, in which:

FIG. 1 is a circuit diagram for explaining a light emitting diode illumination apparatus according to an embodiment of the present invention; and

FIG. 2 is a waveform diagram for explaining an operation of a light emitting diode driving circuit of FIG. 1.

### BEST MODE FOR THE INVENTION

Since a description for the present invention is an embodiment for a structural and functional description, it should not be interpreted that the scope of the present invention is limited by the embodiment described in the body. That is, since the embodiment can be modified in various forms, it should be understood that the scope of the present invention includes equivalents capable of realizing the technical sprit. Furthermore, since the objects or effects proposed in the present invention do not represent that a specific embodiment should include all the objects or effects or should include only such effects, it should not be understood that the scope of the present invention is limited thereby.

The meaning of terms used in the present invention should be understood as follows.

The terms such as “first” and “second” are used for distinguishing one element from another, and the scope should not be limited by the terms. For example, a first element may be named as a second element, and similarly, the second element may also be named as the first element.

It should be understood that when an element is referred to as being “connected” to another element, it can be directly connected to the other element or intervening elements may be present. In contrast, it should be understood that when an element is referred to as being “directly connected” to another element, there are no intervening elements present. Furthermore, other expressions for describing a relation between elements, that is, “between”, “directly between”, “adjacent”, and “directly adjacent” should be interpreted in a like fashion.

It should be understood that the singular forms are intended to include the plural forms as well, unless the context clearly indicate otherwise. It should be understood that the terms “comprise”, “comprising”, “include”, and/or “including”, when used herein, specify the presence of state features, integers, steps, operations, elements, components, and/or groups thereof, but do not preclude the presence or addition of one or more other features, integers, steps, operations, elements, components, and/or groups thereof.

All terms used herein have the same meanings as those generally understood by those skilled in the art of the present invention, unless not specifically defined. It should be understood that terms defined in the dictionary generally used coincide with meanings in the context of the related technology, and it cannot be interpreted that the terms have ideally or excessively formal meanings, unless not clearly defined in the present invention.

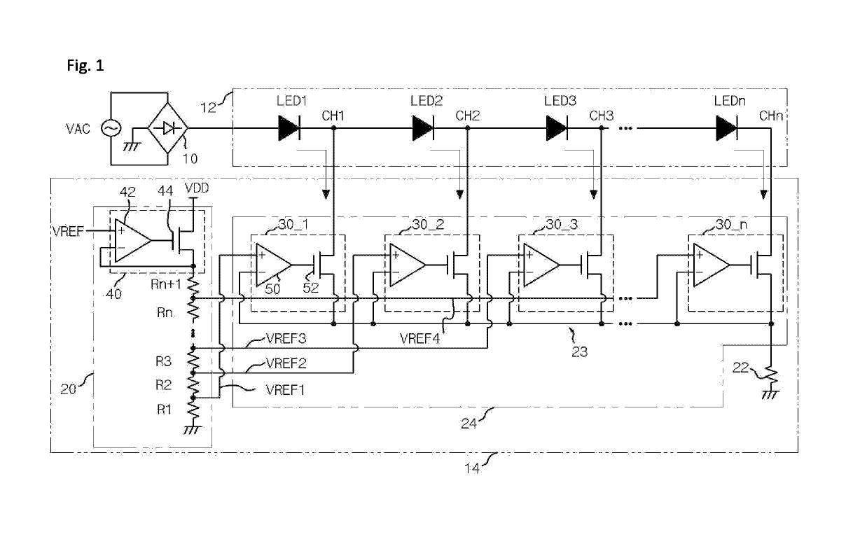

FIG. 1 is a circuit diagram for explaining an LED (Light Emitting Diode) illumination apparatus according to an embodiment of the present invention.

Referring to FIG. 1, the LED illumination apparatus employing an AC direct type includes a rectification circuit (10), an LED illumination (12), and an LED driving circuit (14).

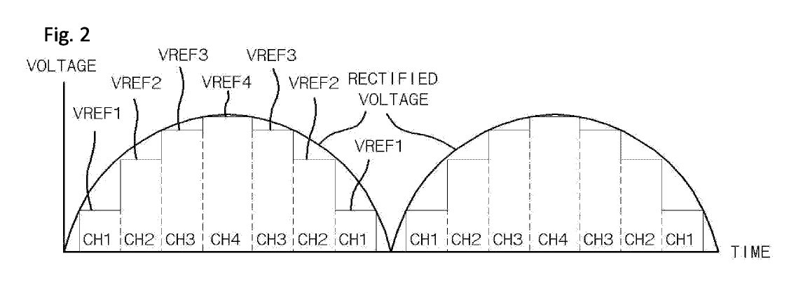

The rectification circuit (10) rectifies an AC voltage of a sine waveform, which is output from an AC power source (VAC), outputs a rectified voltage of a full wave rectified waveform, and provides the rectified voltage to the LED illumination (12) as an input voltage. The AC power source (VAC) may correspond to a commercial AC power source. As illustrated in FIG. 2, the input voltage has a characteristic that it has a time-variable phase and a voltage level of the input voltage rises and falls at a half cycle of the AC voltage.

The LED illumination (12) includes a plurality of LED (Light Emitting Diode) groups (LED1, LED2 . . . LEDn) serially connected to one another, and receives the input voltage from the rectification circuit (10). The plurality of LED (Light Emitting Diode) groups (LED1, LED2 . . . LEDn) form a plurality of channels (CH1˜CH4) through a plurality of LED elements capable of simultaneously flickering by a single LED element or an LED control circuit (14).

The LED control circuit (14) may control the LED illumination (12) and flicker the plurality of LED groups (LED1, LED2, . . . , LEDn). In more detail, when the input voltage rises, the LED control circuit (14) may turn off an LED group (for example, the LED1) corresponding to a previous phase section and turn on an LED group (for example, the LED2) corresponding to a corresponding phase section in an order by which the input voltage is applied. Similarly, when the input voltage falls, the LED control circuit (14) may turn off an LED group (for example, the LED3) corresponding to a previous phase section and turn on an LED group (for example, the LED2) corresponding to a corresponding phase section in an order by which the input voltage is not applied. In an embodiment, in FIG. 1, the order by which the input voltage is applied may correspond to a direction going farther from the rectification circuit (10), that is, a direction of the LED1, the LED2, . . . , the LEDn, and the order by which the input voltage is not applied may correspond to a direction going toward the rectification circuit (10), that is, a direction of the LEDn, . . . , the LED2, the LED1.

The LED control circuit (14) includes a reference voltage generation circuit (20), a common ground resistor (22), a common node (23), and a current supply circuit (24).

The reference voltage generation circuit (20) includes a plurality of resistors R1, R2 . . . Rn, Rn+1 serially connected to one another, and an enable circuit (40). The resistor R1 is connected to the ground, and the resistors Rn+1 is connected to the supply voltage VDD through the enable circuit (40). The resistors Rn+1 corresponds to a load resistor for adjusting the output of the enable circuit (40), and the resistors R1, R2 . . . Rn correspond to load resistors serially connected to one another in order to output different levels of reference voltages (VREF1, VREF2 . . . VREFn). The plurality of reference voltages (VREF1, VREF2 . . . VREFn) may have a higher voltage level in correspondence with an increasing value of the input voltage applied to the plurality of LEDs (LED1, LED2, . . . , LEDn), and the plurality of channels (CH1˜CH4) may be designed in consideration of the voltage levels of the plurality of reference voltages (VREF1, VREF2 . . . VREFn) and an actual change in the input voltage. The reference voltage VREF1 has the lowest voltage level and the reference voltage VREFn has the highest voltage level.

The enable circuit (40) includes a buffer (42) and a NMOS transistor (44). The buffer (42) receives an initial reference voltage VREF through a positive terminal (+) thereof, and commonly connects a negative terminal (−) thereof and a drain of the NMOS transistor (44) to each other. The NMOS transistor (44) receives a supply voltage VDD through a source thereof, connects a gate thereof to the output of the buffer (42), and connects the drain to the resistor Rn+1. The enable control circuit (40) receives the initial reference voltage VREF and provides a stable reference voltage to the plurality of resistors R1, R2 . . . Rn, Rn+1. That is, the buffer (42) receives the initial reference voltage VREF and applies the output of the buffer (42) to the gate of the NMOS transistor (44). When the output of the buffer (42) is applied, the NMOS transistor (44) provides the stable reference voltage to the plurality of resistors R1, R2 . . . Rn, Rn+1.

The common ground resistor (22) is commonly used in the plurality of LED groups (LED1, LED2, . . . , LEDn) serially connected to one another, and the common node (23) has a common voltage that is changed according to the input voltage of the plurality of LED groups (LED1, LED2, . . . , LEDn), and is grounded through the common ground resistor (22).

The current supply circuit (24) includes a plurality of switching circuits (30_1, 30_2, . . . , 30_n), and forms a current path for a current flowing to the common ground resistor (22) from an LED group (for example, the LED2) corresponding to a phase section of the input voltage among the plurality of LED groups (LED1, LED2, . . . , LEDn), based on the common voltage and the plurality of reference voltages (VREF1, VREF2 . . . VREFn). In this case, the plurality of reference voltages (VREF1, VREF2 . . . VREFn) may have an increased voltage level as the distances between the rectification circuit (10) and the plurality of LED groups (LED1, LED2, . . . , LEDn) are increased. If the number of the plurality of LED groups (LED1, LED2, . . . , LEDn) corresponds to 4, the reference voltage (VREFn) applied to the switching circuit (30_3) corresponding to the third LED group (the LED3) may be larger than the reference voltage (VREFn−1) applied to the switching circuit (30_2) corresponding to the second LED group (the LED2).

The plurality of switching circuits (30_1, 30_2, . . . , 30_n) correspond to the plurality of LED groups (LED1, LED2, . . . , LEDn), are connected to the output terminals (that is, the channels CH1, CH2 . . . CHn) of the plurality of LED groups (LED1, LED2, . . . , LEDn), and are commonly connected to the common ground resistor (22) via the common ground resistor (22). Hereinafter, the configuration of each of the switching circuits (30_1, 30_2, . . . , 30_n) will be described.

Each of the switching circuits (30_1, 30_2, . . . , 30_n) includes a phase switch control unit (50) and a phase switch (52). The phase switch (52) is arranged between the output terminal of each of the plurality of LED groups (LED1, LED2, . . . , LEDn) and the common node (23), and selectively forms a current flow through turn-on or turn-off by the output of the phase switch control unit (50), thereby changing the common voltage of the common ground resistor (22). In an embodiment, the common voltage may follow the time-variable phase of the input voltage. In this case, the following indicates the tracing of a flow for the time-variable phase of the input voltage, and for example, may indicate step-like following. The phase switch control unit (50) forms a current flow among the corresponding LED group (LED2), the phase switch (52), and the common node (23) in a corresponding phase section of the input voltage based on the common voltage and a corresponding reference voltage (for example, the VREF2).

In more detail, the phase switch control unit (50) may be realized as a comparator, and the comparator (50) compares the corresponding reference voltage with the common voltage applied to the common ground resistor (22). The comparator (50) commonly connects a negative terminal (−) thereof to the common ground resistor (22), and connects a positive terminal (+) thereof to a specific reference voltage (for example, the VREF2) provided by the reference voltage generation circuit (14).

The phase switch (52) may correspond to a transistor, and the transistor (52) connects a source thereof to the output terminal (that is, the channel CH2) of a corresponding LED (for example, the LED2), connects a gate thereof to the output of the comparator (50), and connects a drain thereof to the negative terminal (−) of the comparator (50) and the common ground resistor (22). Hereinafter, the operation of each of the switching circuits (30_1, 30_2, . . . , 30_n) will be described.

Each of the switching circuits (30_1, 30_2, . . . , 30_n) compares the corresponding reference voltages (VREF1, VREF2 . . . or VREFn) with the common voltage applied to the common ground resistor (22), and forms a current flow in which a current output from the corresponding group LED (for example, the LED2) is transferred to the common ground resistor (22) in the corresponding phase section of the input voltage when the corresponding reference voltage (VREF2) is larger than the common voltage. That is, when the corresponding reference voltage (VREF2) is larger than the common voltage, each of the switching circuits (30_1, 30_2, . . . , 30_n) may form a current flow among the corresponding group LED (for example, the LED2), the corresponding phase switch (52), and the common node (23) in the corresponding phase section of the input voltage, and may not form a current flow among the other corresponding group LEDs (for example, LED1, LED3, . . . , LEDn), the other phase switches (52), and the common node (23) in the other phase sections of the input voltage. In this case, the common voltage of the common ground resistor (22) may be changed according to the turn-on state of the plurality of LEDs (LED1, LED2, . . . , or LEDn) based on the operations of the plurality of switching circuits (30_1, 30_2, . . . , 30_n).

As a consequence, the current supply circuit (24) may selectively form a current path between the LED group (LED1, LED2, or LEDn) turned on by the input voltage and the common ground resistor (22) through the reference voltages (VREF1, VREF2, . . . , VREFn) corresponding to the LED groups (LED1, LED2, . . . , LEDn) and the common voltage. That is, the LED driving circuit and the LED illumination apparatus including the same can define current flows according to the channels of the plurality of serially connected LED groups (LED1, LEDn) by using the single common ground resistor (22).

Hereinafter, the operation of the embodiment according to the present invention will be described in more detail.

FIG. 2 is a waveform diagram for explaining the operation of the light emitting diode driving circuit of FIG. 1.

In FIG. 2, the input voltage rises and falls similarly to the full wave rectified shape of a commercial AC voltage.

The reference voltage generation circuit (20) outputs the plurality of reference voltages (VREF1, VREF2 . . . VREFn) in consideration of the increased value of the input voltage applied to the plurality of LED groups (LED1, LED2 . . . LEDn). The reference voltage generation circuit (20) provides the corresponding switching circuits (30_1, 30_2, or 30_n) with a relatively high reference voltage of the plurality of reference voltages (VREF1, VREF2 . . . VREFn) as the switching circuits (30_1, 30_2, . . . , 30_n) go farther from the application position of the input voltage. In this case, it is preferable that the plurality of reference voltages (VREF1, VREF2 . . . VREFn) are designed in consideration of the common voltage of the common node (23) within the range between a minimum value and a maximum value of the input voltage. More preferably, when each of the plurality of reference voltages (VREF1, VREF2 . . . VREFn) is compared with the common voltage applied to the comparator (50), each of the plurality of reference voltages (VREF1, VREF2 . . . VREFn) may be set to a level at which the corresponding transistor (52) can be turned on.

Each of the switching circuits (30_1, 30_2, . . . , 30_n) compares the corresponding reference voltage (VREF1, VREF2, or VREFn) with the common voltage of the common node (23) to turn on the transistor (52), and forms a current flow in a corresponding phase section of the input voltage when the corresponding reference voltage (VREF1, VREF2, or VREFn) is larger than the common voltage. As the input voltage increases, each of the switching circuits (30_1, 30_2, . . . , 30_n) forms a current flow in a direction going farther from the application position of the input voltage, that is, a direction from the LED group (LED1) to the LED group (LEDn), and as the input voltage decreases, each of the switching circuits (30_1, 30_2, . . . , 30_n) forms a current flow in a direction going toward the application position of the input voltage, that is, a direction from the LED group (LEDn) to the LED group (LED1).

Hereinafter, an operation relation between the plurality of LED groups (LED1, LED2, . . . , LEDn) and the plurality of switching circuits (30_1, 30_2, . . . , 30_n) will be described.

First, the input voltage does not turn on the LED group (LED2) in a rising process, but turns on the LED group (LED1) when the input voltage exceeds a level at which the LED group (LED1) can be turned on. A current is supplied to the switching circuit (30_1) (that is, the source of the transistor (52)) from the LED group (LED1) because the LED group (LED2) is not turned on.

In the switching circuit (30_1), the negative terminal (−) of the comparator (50) receives a current common voltage of the common node (23) in an initial state, and the positive terminal (+) of the comparator (50) receives the reference voltage (VREF1) capable of turning on the transistor (52). As a consequence, in the switching circuit (30_1), the transistor (52) is turned on, and the common voltage of the common node (23) rises by a current supplied to the common ground resistor (22) through the transistor (52) in the LED group (LED1). In this case, the transistors (52) in the other switching circuits (30_2, . . . , 30_n) are also turned on, but a current flows through the switching circuit (30_1) positioned on the shortest path in a current phase section of the input voltage. That is, even though the transistor (50) is turned on, the common node (23) forms a current flow between the output terminal of the LED group (LED1) and the ground connected to the common ground resistor (22) only in a corresponding phase section of the input voltage.

Since the common voltage is commonly applied to the switching circuits (30_1, 30_2, . . . , 30_n), the common voltage applied to the negative terminal (−) of the comparator (50) in each of the switching circuits (30_1, 30_2, . . . , 30_n) rises. When the input voltage rises in the turn-on state of the switching circuit (30_1), the common voltage also rises, and when the common voltage is equal to or larger than the reference voltage (VREF1), the switching circuit (30_1) blocks the current flow.

Before and after or simultaneously to such blocking, since the transistors (52) in the other switching circuits (30_2, . . . , 30_n) have been turned on, a current flow is formed through the switching circuit (30_2) having the shortest path in the current phase section of the input voltage. Such a current flow is formed up to the common ground resistor (22) via the LED groups (LED1 and LED2) and the common node.

The input voltage repeats such processes in the rising process, so that a current path is finally formed through the switching circuit (30_n). That is, the current path is sequentially changed from a near position to a far position at a position, to which the input is applied, as the input voltage (that is, the rectified voltage) rises. Accordingly, the turn-on state of each of the switching circuits (30_1, 30_2, . . . , 30_n) is shifted from the near position to the far position at the position to which the input is applied, and the LED groups (LED1, LED2, . . . , LEDn) are sequentially turned on one by one in a direction going farther from the position to which the input voltage is applied. After all the LED groups (LED1, LED2, . . . , LEDn) are turned on, the rectified voltage falls.

Next, in a falling process, when the common voltage falls and the input voltage falls below a level at which the LED group (LEDn) is turned on, the LED group (LEDn) is turned off, and the common voltage (that is, the common voltage of the common node (23)) applied to the common ground resistor (22) falls by a current supplied through the light emitting diode (LED3), which is the farthest from the position to which the input voltage is applied, among the emitted LED groups (LED1, LED2, and LEDn), and the switching circuit (30_3).

The switching circuit (30_3) is turned on in the turn-on state of the switching circuit (30_n), a current flow is formed through the switching circuit (30_3) having the shortest path in the current phase section of the input voltage, and a current flow through the switching circuit (30_n) is blocked. Such a current flow is formed up to the common ground resistor (22) via the LED groups (LED1, LED2, and LED3) and the common node.

The current path is sequentially changed from the far position to the near position at the position, to which the input is applied, as the input voltage falls, and the turn-off state of each of the switching circuits (30_1, 30_2, . . . , 30_n) is sequentially shifted from the far position to the near position at the position to which the input is applied, and the LED groups (LED1, LED2, . . . , LEDn) are sequentially turned off one by one in a direction going toward the position to which the input voltage is applied. The input voltage repeats such processes in the falling process, so that a current path is finally formed through the switching circuit (30_1).

As a consequence, in the LED driving circuit and the LED illumination apparatus including the same according to the embodiment of the present invention, the rectified voltage may rise and fall according to the common voltage by a current flowing through the single common ground resistor (22), and the LED groups (LED1, LED2, . . . , LEDn) may be additionally turned on one by one in a direction going farther from a position to which the rectified voltage is applied, or may be additionally turned off one by one in an opposite direction.

In the LED driving circuit and the LED illumination apparatus including the same according to the embodiment of the present invention, it is possible to correct a power factor through a common voltage following an input voltage without using an inductor or a capacitor, and to ensure a current regulation characteristic.

In the LED driving circuit and the LED illumination apparatus including the same according to the embodiment of the present invention, it is possible to form current paths according to the channels of the plurality of LED groups (LED1, LED2, . . . , LEDn) by using the single common ground resistor (22), so that it is possible to simplify parts in the LED driving circuit, and thus the LED driving circuit and the LED illumination apparatus can be realized with a simple structure.

Although a preferred embodiment of the present invention has been described for illustrative purposes, those skilled in the art will appreciate that various modifications, additions and substitutions are possible, without departing from the scope and the spirit of the invention as disclosed in the accompanying claims.

1. An LED driving circuit that drives a plurality of serially connected LED (Light Emitting Diodes) groups by using a rectified voltage obtained by rectifying an AC voltage, comprising:
a reference voltage generation circuit that generates a plurality of reference voltages corresponding to the plurality of LED groups and having levels different from each other;
a common ground resistor; and
a plurality of switching circuits connected to output terminals of the plurality of LED groups, receiving a high reference voltage as the LED groups go farther from a position to which the rectified voltage is applied, and receiving a corresponding reference voltage and a common voltage of the common ground resistor and forming a current path between a corresponding LED group and the common ground resistor for changing the common voltage of the common ground resistor, the current path being formed between an LED group, which is farthest from the position to which the rectified voltage is applied among currently turned-on LED groups, and the common ground resistor.

2. The LED driving circuit of claim 1, wherein the reference voltage generation circuit includes a plurality of serially connected resistors to which a supply voltage is applied, and nodes in the plurality of resistors output the plurality of reference voltages.

3. The LED driving circuit of claim 2, wherein the reference voltage generation circuit further comprises:
an enable circuit that selectively activates application of the supply voltage to the plurality of resistors by an initial reference voltage.

4. The LED driving circuit of claim 1, wherein each of the plurality of switching circuits comprises:
a comparator that compares the corresponding reference voltage with the common voltage; and
a switching element that selectively forms the current path by output of the comparator and changes the common voltage of the common ground resistor.

5. An LED driving circuit that drives a plurality of LED (Light Emitting Diode) groups, comprising:
a common node having a common voltage that is changed according to an input voltage of the plurality of LED groups, the input voltage having a time-variable phase;
a plurality of phase switches arranged between output terminals of the plurality of LED groups and the common node; and
a plurality of phase switch control units that form current flows among a corresponding LED group, a corresponding phase switch, and the common node in phase sections of the input voltage based on the common voltage and a corresponding reference voltage.

6. The LED driving circuit of claim 5, wherein each of the plurality of phase switch control units forms the current flow in a corresponding section of the input voltage, and does not form the current flow in remaining phase sections.

7. The LED driving circuit of claim 5, wherein the common node connects output terminals of the plurality of phase switches, input terminals of the plurality of phase switch control units, and a common ground resistor connected to ground to one another.

8. The LED driving circuit of claim 7, wherein the common node forms a current flow between an output terminal of the LED (Light Emitting Diode) and the ground only in a corresponding phase section of the input voltage even though at least a part of the plurality of phase switches is turned on.

9. The LED driving circuit of claim 7, wherein the common voltage follows the time-variable phase of the input voltage.

10. The LED driving circuit of claim 5, wherein each of the plurality of phase switch control units turns on the phase switch when the corresponding reference voltage is higher than the common voltage.

11. The LED driving circuit of claim 10, wherein each of the plurality of phase switch control units includes a comparator that receives the corresponding reference voltage through a positive terminal, receives the common voltage through a negative terminal, and connects a corresponding phase switch to an output terminal.

12. The LED driving circuit of claim 5, further comprising:
a reference voltage generation unit that generates a plurality of reference voltages corresponding to a plurality of phase sections of the input voltage and provides a reference voltage corresponding to the corresponding phase section as the corresponding reference voltage.

13. The LED driving circuit of claim 5, further comprising:
a power supply that provides the input voltage to an input terminal of the LED group.

14. The LED driving circuit of claim 5, wherein the plurality of phase switch control units receive a high reference voltage as the LED group goes farther from a position to which the input voltage is applied, receive a corresponding reference voltage and the common voltage, and form a current path between a corresponding LED group and the common node to change the common voltage, the current path being formed between an LED group, which is farthest from the position to which the rectified voltage is applied among currently turned-on LED groups, and the common ground resistor.

15. An LED illumination apparatus including an LED (Light Emitting Diode) group and an LED (Light Emitting Diode) driving circuit, wherein the LED driving circuit comprises:
a common node having a common voltage that is changed according to an input voltage of the LED group, the input voltage having a time-variable phase;
a phase switch arranged between an output terminal of the LED group and the common node; and
a phase switch control unit that forms a current flow among the LED group, the phase switch, and the common node in a corresponding phase section of the input voltage based on the common voltage and a corresponding reference voltage.

16. An LED driving circuit that drives N (N is a natural number) serially connected LED (Light Emitting Diode) groups, comprising:
a common ground resistor; and
N switching circuits connected to output terminals of the LED groups, commonly connected to the common ground resistor, and corresponding to the LED groups,
wherein, in the N switching circuits, a N^{th} switching circuit receives a high reference voltage as compared with a N−1^{th} switching circuit and forms a current path between a N^{th} LED group and the common ground resistor.

17. The LED driving circuit of claim 16, further comprising:
a reference voltage generation circuit that applies a higher reference voltage to the N^{th} switching circuit as compared with the N−1^{th} switching circuit.

18. The LED driving circuit of claim 17, wherein the switching circuit comprises:
a comparator that compares the reference voltage with the common voltage; and
a switching element that is turned on and off by output of the comparator, selectively forms the current path, and changes the common voltage of the common ground resistor.

19. The LED driving circuit of claim 17, wherein a rectified voltage obtained by rectifying an AC voltage is applied to the LED groups.

20. The LED driving circuit of claim 18, wherein the reference voltage generation circuit includes a plurality of serially connected resistors to which a supply voltage is applied, and outputs reference voltages according to nodes between the plurality of resistors.

21. The LED driving circuit of claim 20, wherein the reference voltage generation circuit further comprises:
an enable circuit that selectively activates application of the supply voltage to the plurality of resistors by an initial reference voltage.
